(19) United States
(12) Patent Application Publication
(10) Pub. No.: US 2017/0357927 A1
(43) Pub. Date: Dec. 14, 2017

(54) PROCESS MANAGEMENT FOR DOCUMENTATION-DRIVEN SOLUTION DEVELOPMENT AND AUTOMATED TESTING

(71) Applicant: ACCENTURE GLOBAL SOLUTIONS LIMITED, Dublin (IE)

(72) Inventors: Emmanuel Benbinuto ANTONIO, Mandaluyong (PH); Darwin Endaya Flores, Apalit (PH); Joseph Christian Policarpio Tamayo, Pasig (PH); John Nikko Nicolas, Rizal (PH); Raye Willson Paez Raymundo, Batangas (PH)

(73) Assignee: ACCENTURE GLOBAL SOLUTIONS LIMITED, Dublin (IE)

(21) Appl. No.: 15/616,518

(22) Filed: Jun. 7, 2017

Related U.S. Application Data
(60) Provisional application No. 62/348,499, filed on Jun. 10, 2016.

(51) Int. Cl. G06Q 10/06; G06F 17/24; G06F 17/30; G06F 17/21; G06F 17/27

(52) U.S. Cl. CPC G06Q 10/06316; G06F 17/30011; G06F 17/212; G06F 17/248; G06F 17/2765

(57) ABSTRACT

A process manager that is automatically generated from human-readable project documents is used to generate the requirements documents for an application. The process manager also automatically generates the application based on the requirements documents. The project documents are analyzed to retrieve the configuration scripts, project templates and processes that are used for the generation of the process manager which includes machine-readable instructions responsive to the objectives. Project documents may additionally be generated in order to fine tune the process manager. The process manager generates the requirements documents and based on the requirements documents automatically generates the application. The object and configuration documentation and test results documents for the application is also automatically generated.

### CROSS REFERENCE TO RELATED APPLICATIONS

The present application claims priority under 35 U.S.C. 111(b) to U.S. provisional patent application number 62/348,499, having a filing date of Jun. 10, 2016, the disclosure of which is hereby incorporated by reference in its entirety.

### BACKGROUND

Systems development or application development involves various stages such as planning, creating, testing and deploying the information system. The development can involve both the hardware and software elements of the information system. Computer systems tend to be complex with various traditional systems being supported even as new applications and hardware are developed and installed during various maintenance or upgrade operations. Developing effective and efficient Information Technology (IT) systems is the key to success for many organizations. Solutions including applications that run on computing devices may be developed for various aspects of the IT systems. In order to succeed in the current environment, organizations need easy-to-use process management tools that enable rapid solution development and allow them to make impactful changes.

### BRIEF DESCRIPTION OF DRAWINGS

Features of the present disclosure are illustrated by way of examples shown in the following figures, in which:

FIG. 1 is a block diagram showing the details of a management system generator that automatically develops a process manager in accordance with an example.

FIG. 2 shows a block diagram of an analytics engine included in the management system generator in accordance with an example.

FIG. 3 is a block diagram detailing the elements of a developer included in the management system generator in accordance with an example.

FIG. 4 is a block diagram that shows the details of the process manager that is developed by the management system generator in accordance with an example.

FIG. 5 is a block diagram of a creator included with the process manager in accordance with one example.

FIG. 6 is a flowchart that details a method of generating the process manager in accordance with an example.

FIG. 7 is a flowchart detailing the execution of process steps by the process manager in accordance with one example.

FIG. 8 is a flowchart that details a method of executing a process step in accordance with an example.

FIG. 9 is a flowchart that details a method of automatic creation of the step artifact in accordance with one example.

FIG. 10 is a flowchart that details a method of configuring the step artifact in accordance with an example.

FIG. 11 is a flowchart that details a method of identifying existing code or configuration from the solutions database in accordance with an example.

FIG. 12 is a flowchart that details a method of testing and validation of production objects in accordance with an example.

FIG. 13 is a flowchart that details a method of automatically generating project metrics in accordance with an example.

FIG. 14 is a flowchart that details a method of archiving project data.

FIGS. 15A and 15B show example user interfaces (UIs) that are automatically generated in accordance with examples disclosed herein.

FIG. 16 illustrates a computer system that may be used to implement one or more of the management system generator, the process manager with automated testing and documentation generation and the production objects.

### DETAILED DESCRIPTION

For simplicity and illustrative purposes, the present disclosure is described by referring mainly to examples thereof. In the following description, numerous specific details are set forth in order to provide a thorough understanding of the present disclosure. It will be readily apparent however that the present disclosure may be practiced without limitation to these specific details. In other instances, some methods and structures have not been described in detail so as not to unnecessarily obscure the present disclosure. Throughout the present disclosure, the terms “a” and “an” are intended to denote at least one of a particular element. As used herein, the term “includes” means includes but not limited to, the term “including” means including but not limited to. The term “based on” means based at least in part on.

A system for configuration-driven process management that enables automatic generation and configuration of applications or solutions based on documentation is disclosed. The system further allows automated testing of the applications and automatically documenting the development and the testing processes. The applications can include machine-readable instructions that are executed by processors of computing systems for executing certain tasks. An example of an application that can be automatically generated as detailed herein can be a dashboard for a monitoring system. Various elements of the dashboard such as but not limited to, user interface elements that visibly convey data to users, connections to data sources for retrieving data and widgets for processing the retrieved data can be automatically generated in accordance with examples described herein.

A process manager is initially generated from project documents which may include, for example, project objectives, deliverables, schedule, risks, methodology and other key project plan information in human-readable formats. Solutions database stores the core data, information and systems needed to generate the process manager which is further employed to implement or execute the project which includes development and configuration of one or more applications.

The process manager receives artifacts which are validated to ensure that the requirements of the current process are met. The input artifacts may refer to documents, deliverables or work items that are produced, modified or otherwise employed during the course of the project. In an example, the artifacts may be created by the various processes executed by the process manager to meet project deliverables. Some of the created artifacts serve as requirements documents based on which the various production objects of the application are developed and configured as part of a successful project implementation. The requirements documents are loaded into the process manager to implement and document the applications in the project's Information Technology (IT) systems which may include development systems that are used to test the application and production systems on which the application is ultimately deployed. The implementation documentation may be a series of human-readable documents such as object/configuration documentation and test results documents that details the implementation and are available for later use. The applications thus developed are tested and documented either through the process manager itself or through external applications. In an example, the external applications may refer to applications that are not inherently part of the process manager. Project metrics are also generated based on the data from the generated process manager. In an example, project metrics may refer to quantifiable information processed from data available from the process manager.

The configuration-driven process management solution disclosed herein is composed of two parts: a management system generator and utilization of the generated process manager to deliver a project through artifact management and validation. As mentioned above, one or more project documents are provided as input to the management system generator. The project documents may include project objectives, deliverables, schedule, risks, methodology and other project plan information. The contents of the project plan documents are analyzed to determine the processes, templates, tools and other enablers that need to implemented or enabled to meet the requirements by using the solution master database. A solutions database contains the information related to processes, templates, roles, historical data, and other information needed to analyze the input and to generate the process management system. The results of the analysis are used to provide the process configurations, templates, project processes and other components from which the process manager is generated. In an example, additional project documents may also be generated during the generation of the process manager. The additional project documents are fed back as input to the management system generator for fine tuning the process manager to meet the requirements.

The generated process manager may be used to implement a project in one example. The input artifacts used for implementing the project are initially validated upon receipt to ensure that the artifacts meet the requirements of format, size and other attributes. In particular, each step's artifact is created to meet the project deliverables. Artifacts such as, documents, deliverables, executable code modules or other work items are produced, modified or used by the process manager during the project implementation. The process manager retrieves, scheduled and/or by-demand, relevant project data to generate the project metrics and analysis report document. The processed data is thus converted into human-readable format. The project closure documents are validated in a procedure similar to the project plan documents prior to implementing the project. The project's transaction data is archived for future reference.

In an example, the process manager defines multiple steps which may be grouped into phases. Phases are configured to determine project processes. In an example, steps and processes can be rearranged depending on requirements. Based on the configuration, the relevant input, output checks may be combined to simplify processes. For example, a step may receive an input artifact, process or analyze the information from the input artifact and produce an output artifact from the analysis. The input artifact to a process step may be validated to ensure that it is usable to create the step's artifact. Examples of input artifacts may include but are not limited to, documents, deliverables and other work items produced, modified and/or to be used by the step to produce its artifact. Similarly, a step artifact may include but is not limited to, a document, deliverable and/or work item produced, updated and/or modified, by the process step but has not yet been validated. An output artifact may include a document, deliverable or a work item produced, updated or modified by the process step (i.e., a step artifact) that has been validated.

A document-driven development of applications with automated testing and documentation is disclosed in an example. One or more requirements documents which are validated for their attributes such as size, format and the like are accessed. The contents of the requirements documents are then converted into the implementation format file or machine readable instructions that form production objects which serves as input to the implementation and testing functions. The production objects include formatted instructions needed to implement the solutions analyzed from the requirements.

The implementation function begins by optimizing the production objects to ensure correct sequence, quality and performance of the implementation instructions. The production objects which are thus optimized are sent to the relevant development (DEV) systems where they are programmatically implemented via the corresponding API layer. The API layer enables interfacing with other systems and technical applications. The implementation instructions within the production objects are converted to human-readable format so as to generate the object/configuration documentation that can be referred to for later use. Based on the instructions from the production objects, the implementation's test scripts are validated to begin the testing function of the solution. In an example, the testing function of the solution can be executed in parallel with the generation of the implementation documentation. Upon the validation of the test scripts, the unit tests are executed either directly in the development systems or via a unit testing module. In an example, the unit test module may be an application used to execute, validate and/or document unit tests on development systems. After running the unit tests, the solution documents the test results either directly or via the unit testing module in order to produce the unit test documentation. The implementation unit test documentation may be a series of human-readable documents that can be referred to for later use. A user is then informed to obtain validation on the implementation, unit tests and their corresponding documentation. When the implementation, unit tests and their corresponding documentation are validated by the user, the process manager pushes the production objects to the relevant quality assurance systems (QAS).

The automatic generation of the process manager that is further employed to achieve document-driven application development is a technical improvement over systems wherein requirements from human-readable requirement documents are converted into machine-readable code manually. Furthermore, the developed code is also moved manually through testing and documentation processes. The process manager which is automatically developed from the project documents along with the corresponding project documents that detail the development and implementation details of the process manager is not only able to automatically convert the human-readable project documents into machine-readable code but can also simultaneously document the development and implementation process of the project in human-readable formats. Thus, the configuration driven process manager and the document-driven automatic application development by the process manager enable automatic, seamless conversion of human-readable documents into machine-readable code and vice versa. Moreover, further fine-tuning of the process manager from the corresponding automatically developed project documentation enables a feedback mechanism that leads to the application development process improving with usage. The document-driven application development described herein enables automating the development, testing and documenting cycles of the application development process thereby vastly reducing the time taken for these cycles. The examples described herein enable rapid application development within days or even hours where the similar tasks used to be executed over weeks when done manually in traditional systems.

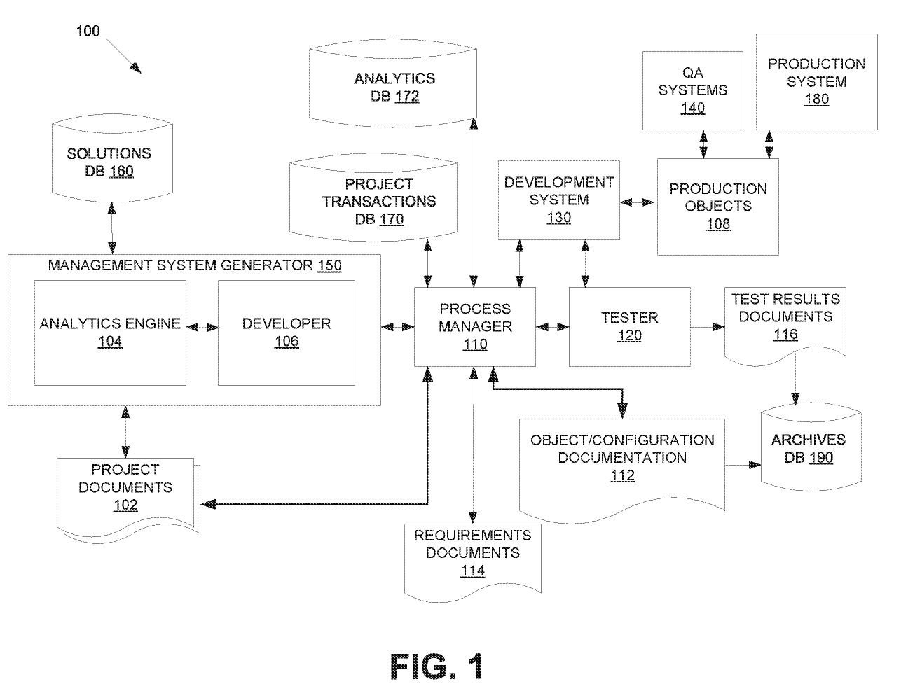

FIG. 1 is a block diagram showing the details of an a management system generator 150 that automatically generates a process manager 110. The process manager 110 generates requirements documents 114 of a project for a development system 130. The process manager 110 also automatically generates production objects 108 that are ready to be loaded into the development system 130 in addition to documenting the object and configuration details in the object and configuration documentation 112 and testing details in the test results documents 116. The project documents 102 are produced in human-readable format during the planning phase of a development cycle when the source of a problem or need for improvement is identified, various solutions are evaluated and a best fit for the improvement is selected. The project documents 102 may detail the necessary project objectives, deliverables, schedule, risks, methodology and other key project plan information that will satisfy the function project of the proposed improvements. The project documents 102 may be formatted as spreadsheets, as textual documents, or documents with markup such as Extendible Markup Language (XML) files.

The management system generator 150 receives and analyzes the project documents 102 and based on the analysis, automatically generates the process manager 110. The analytics engine 104 included in the management system generator 150 analyzes the project documents 102 using data from the solutions database 160 to determine the various processes, templates, configuration scripts and the like that are required for generating the process manager 110. In an example, Artificial Intelligence (AI) techniques as detailed herein may be employed for using the data from the solutions database 160 to generate the process manager 110 by the developer 106. The process manager 110 may be developed based on the attributes of the development system 130. For example, if the development system 130 for which the process manager 110 is to create production objects 108 is based on ORACLE technologies, then the process manager 110 may be developed in JAVA. In another example, if the development system 130 is an SAP system, then combinations of JAVA, SAP High-performance Analytic Appliance (HANA) and SPLUNK can be used.

The process manager 110 thus generated, further generates the requirements documents 114, analyzes the requirements documents 114 to identify the configuration, development and testing steps or processes needed for meeting the requirements by employing for example, the analytics database 172. The analysis may be achieved by employing Al techniques with big data. The process manager 110 can execute various processes and sub-processes using the project transactions database 170. The process manager 110 not only generates the production objects but also the objects and configuration documentation 112 which shows the status of each implementation along with the corresponding configurations in human-readable format. The production objects 108 from the process manager 110 may be loaded into a tester 120 for testing. The tester 120 can be a technical application external to the process manager 110 that is used to execute, validate and/or document unit tests on the development system 130. The production objects 108 that are determined as ready for deployment upon testing, are uploaded to the production system 180. In an example, the implementation of the production objects 108 on the development system 130 may be further validated, tested or executed to ensure quality prior to moving to the production system 180. The objects and configuration documentation 112 and the test results documents 116 may be stored within the archives database 190. The automatic generation of tools such as the process manager 110 that further enable automation of the application development and documentation processes leads to vast gain in efficiencies of application development processes as it mitigates the need for multiple process-steps that need to be manually executed.

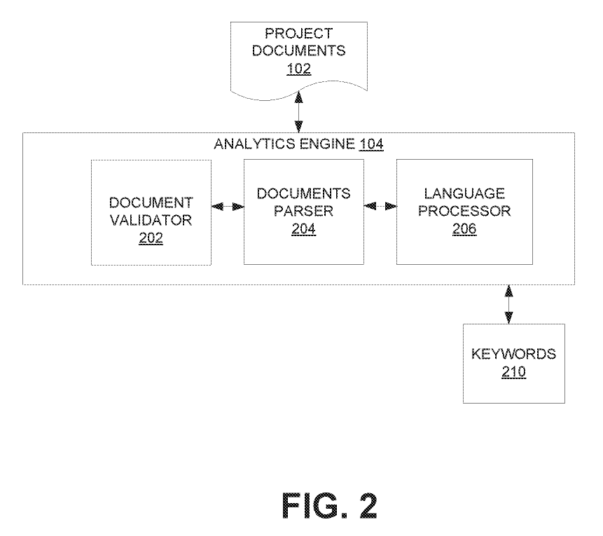

FIG. 2 shows a block diagram of the analytics engine in accordance with an example. The analytics engine 104 analyzes the project documents 102 which include project specifications and requirements in order to extract keywords 210 that are further employed in the development of the process manager 110. In an example, the analytics engine 104 includes a document validator 202 that validates key attributes of the project documents 102 such as format, size, and other similar details. A document parser 204 comprised in the analytics engine 104 parses the project documents 102 in order to generate word tokens. The word tokens are uploaded to a language processor 206 for the extraction of the keywords 210. In an example, the language processor 206 processes the input from the document parser 204 to remove spaces, stop words and the like. The processed word tokens that are obtained from the language processor 206 form a list of words that can be used as keywords 210. Thus, keywords 210 are extracted from the project documents 102 detailing the processes, templates, other tools that need to be implemented or enabled to meet the requirements.

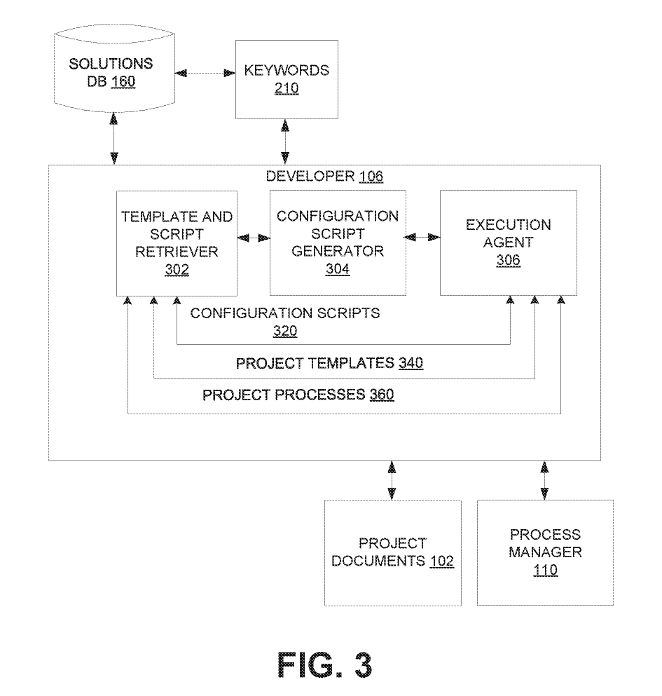

FIG. 3 is a block diagram detailing the elements of the developer 106 in accordance with an example. The template and script retriever 302 included in the developer 106 receives the keywords 210 from the analytics engine 104. The keywords 210 are used to retrieve the configuration scripts 320, project templates 340, and project processes 360 from the solution database 160. The solutions database 160 contains analytics information related to processes, templates, roles historical data and other information needed to analyze the input and to generate the process manager 110. In an example, configuration scripts are sets of machine-readable instructions that are followed to configure the process manager 110. The project templates 340 are documents that serve as templates for different processes. For example, project templates 340 can be files formatted as spreadsheets or XML files. The project processes 360 are sets of processes that should be followed within a project. If one or more configuration scripts 320 could not be retrieved from the solutions database 160, the configuration scripts generator 304 generates the configuration scripts using Al techniques outlined herein.

The execution agent 306 uses the configuration scripts 320 which include lines of code to programmatically configure the process manager 110 using either a front end or a backend of the process manager 110. The project templates 340 are loaded into the memory of a computing device executing the developer 106 for the generation of the process manager 110 and the project processes 360 that will be followed in generating the project objects are initialized. In addition to the process manager 110, the developer 106 may also generate additional documentation that is added to the project documents 102. The additional project documents that are generated serve as input to the management system generator 150 in a feedback process to fine tune the process manager 110 to meet the requirements.

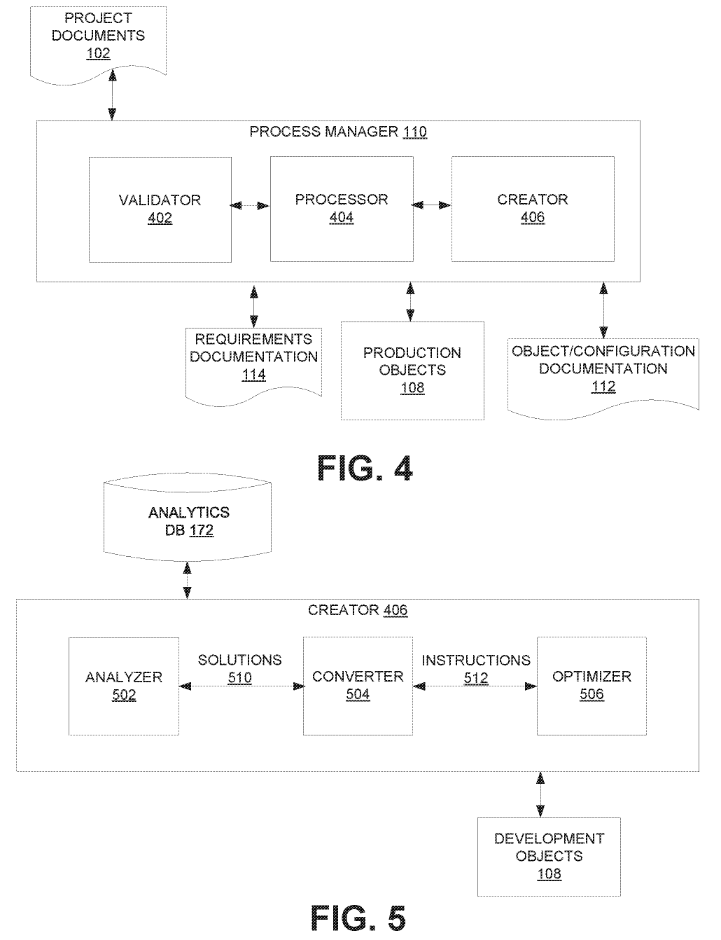

FIG. 4 is a block diagram that shows the details of the process manager 110 that is developed by the management system generator 150 in accordance with an example. The process manager 110 accesses input artifacts of the project to be deployed on to the production system 180 for one or more of improvements, upgrades or additions. In an example, the production system 180 can be a third-party system that is external to the process manager 110, although the process manager 110 and the production system 180 may share the same technological or programming platforms in order for the process manager 110 to be able to automatically generate the development 108 objects for the production system 180. By the way of illustration and not limitation, the production system 180 may be a monitoring platform and the process manager 110 can develop a dashboard including a Graphical User Interface (GUI) for monitoring the various processes on the monitoring platform.

A validator 402 included in the process manager 110 validates input artifacts that include project documents 102 such as the deliverables or work items including code modules in order to check for compliance of the various attributes such as size, format and the like. If the project documents 102 comply with the norms for the various attributes, they are transmitted to a creator 406 for the generation of the various step artifacts such as, production objects and/or configuration scripts and related documentation. A processor 404 may identify processes and sub-processes to be executed from the project documents 102. The creator 406 creates, for each process step or the sub-process step, a step artifact which may include an object, a script or the object/configuration documentation 112 which is generated in accordance with methods described herein. In an example, the step artifacts can be requirements documents 114 which can serve as inputs for downstream processes that create output artifacts such as the production objects 108 and related documentation such as the object/configuration documentation 112. The requirements documents 114 may include development standards, functional requirements, requirements definitions and the like. The output artifacts from the process manager 110 include the production objects 108 which may be further uploaded to the tester 120 for testing and evaluation on the development system 130. The production objects 108 that are thus tested automatically or manually by the tester 120 and QA systems 140 on the development system 130 to ensure completeness as per requirements specified in the project documents 102 are finally deployed on to the production system 180. The output from the process manager 110 may also include the object/configuration documentation 112 which can be stored in the archives database 190 for future use.

FIG. 5 is a block diagram of the creator 406 in accordance with one example. The creator 406 includes an analyzer 502 which analyzes the contents of the requirements documents 114 by employing the analytics database 172 to determine the configuration, development and testing steps or solutions 510 that are to be executed in order to meet the requirements. The analytics database 172 contains the relevant data and information needed to analyze, process and convert the project documents 102 into production objects 108 and related documentation. A converter 504 included in the creator 406 converts the solutions 510 into instructions 512 which are further optimized by an optimizer 506. In an example, the converter 504 can parse the requirements documents 114 to obtain keywords which are used to retrieve from the analytics database 172, implementation scripts or test scripts which include machine-readable instructions for the production objects 108 in accordance with examples detailed herein. If no implementation scripts could be retrieved from the analytics database 172, the creator 406 can generate an implementation script as detailed further infra.

The production objects 108 thus contain the machine-readable instructions 512 that are optimized and formatted to enable the development system 130 to implement the solutions 510 determined from the requirements documents 114. The optimizer 506 optimizes the instructions 512 to ensure correct sequence of instructions, quality and performance. The production objects 108 which contain optimized instructions, are uploaded to the development system 130 where the instructions are programmatically implemented for example, via the development system's 130 Application Programming Interface (API) layer.

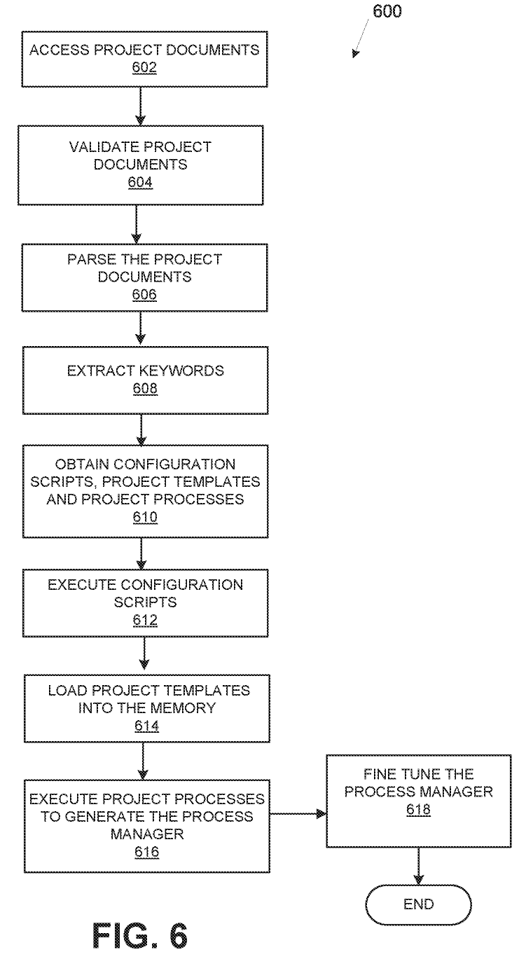

FIG. 6 is a flowchart 600 that details a method of generating the process manager 110 in accordance with an example. The method begins at 602 wherein the project documents 102 are accessed. The project documents 102 are validated at 604 for determining their compliance with format, size and other similar details. The project documents 102 are parsed at 606 to obtain word tokens and the keywords 210 are extracted at 608 by processing the word tokens to remove spaces, punctuations, stop words and the like. The keywords 210 are used at 610 to obtain the configuration scripts, project templates and project processes using the data from the solution database 160. The instructions to configure the process manager 110 included in the configuration scripts 320 are executed at 612. The project templates 340 for the various processes are loaded into the memory at 614 and the project processes 360 are executed at 616 to generate the process manager 110. In addition, project documents 102 may be additionally generated at 614 which can be used to provide feedback for fine tuning the process manager at 618.

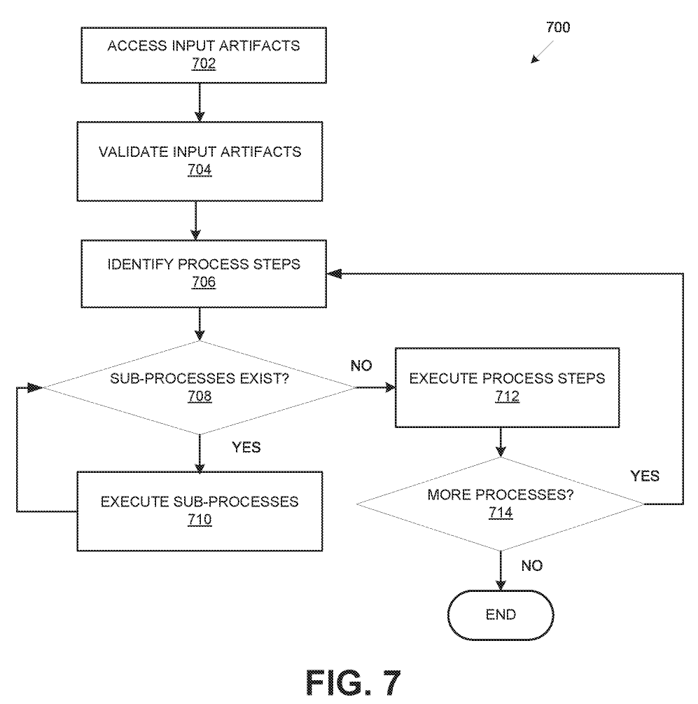

FIG. 7 is a flowchart 700 detailing the execution of process steps by the process manager 110 in accordance with one example. The method begins at 702 wherein the input artifacts related to the process in execution are accessed. The input artifacts can include project documents 102, configuration scripts, code modules and the like that are necessary for the execution of the process steps. The input artifacts are then validated 704 prior to being employed for the process. The validation procedure to determine the usability of an input artifact may include determining that the various attributes such as size and formats comply with the requirements of the process. If the input artifacts do not comply with the process requirements, the process may be terminated on the end block. Upon validation of the input artifacts, the various process steps are identified at 706. As part of the process step identification, it may be determined at 708 if further sub-processes exist within each of the process steps based for example, on the project templates 340. If no sub-processes exist within the process step, the process steps identified at 706 are executed at 712. It is determined at 714 if more processes need to be executed. If no more processes are to be executed, the method terminates on the end block. If more processes are to be executed, the method returns to 706 to identify the process steps for execution.

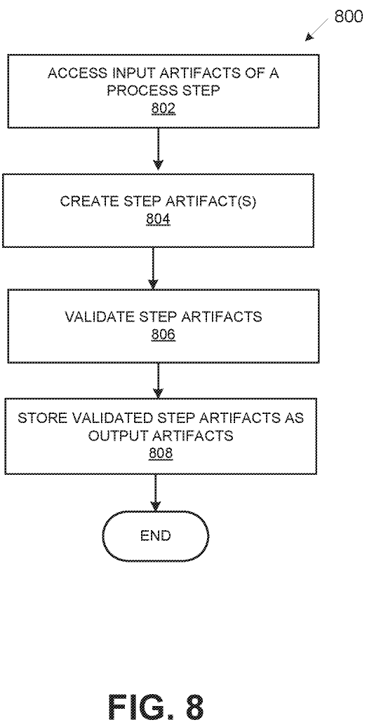

FIG. 8 is a flowchart 800 that details a method of executing a process step in accordance with an example. The method begins at 802 wherein the input artifacts of the process step are retrieved. The input artifacts are used to execute the process step wherein one or more step artifacts are created at 804. The successful execution of the process step at 804 can be determined based on the quality of the step artifact created at 804. A step artifact can refer to a document, a configuration script, a code module or other work item that is produced, updated and/or modified during a process step but has not yet been validated. Upon the validation at 806, the validated step artifact, which may now be referred to as an output artifact is stored at 808.

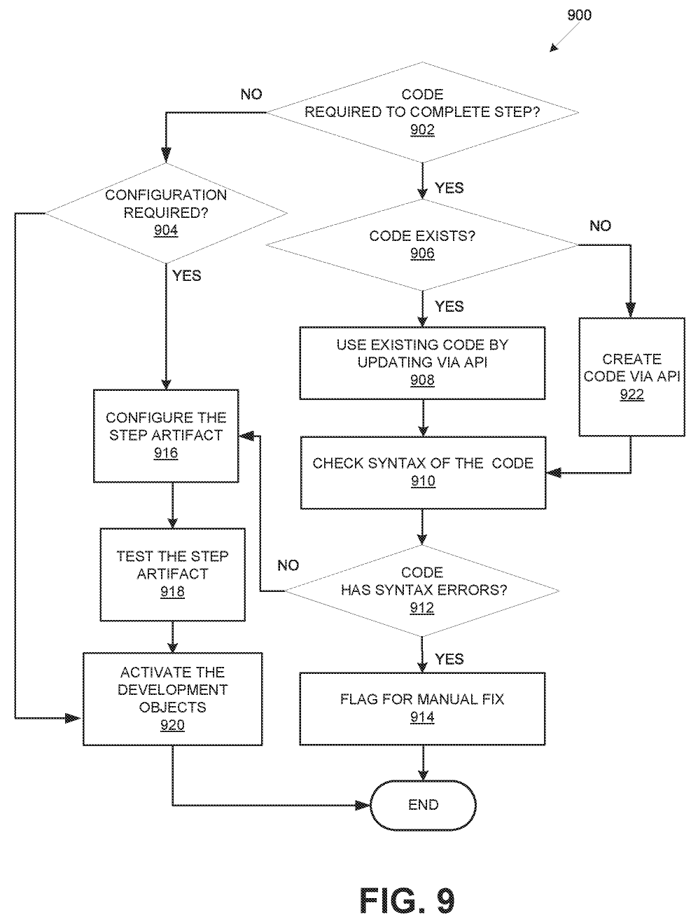

FIG. 9 is a flowchart 900 that details a method of automatic creation of the step artifact in accordance with one example wherein the step artifact is tested and upon approval, is stored as one of the production objects 108. The method begins at 902 wherein it is determined if a process step requires code or machine-readable instructions for completion. For example, the process step may employ code for meeting a requirement from the requirements document 412. If, at 902, it is determined that no code is required to complete the process step, the method proceeds to 904 to determine if a configuration of one or more step artifacts is required. If it is determined at 904 that the configuration of one or more step artifacts is required, the method proceeds to 916 to configure the step artifact. The step artifact which is configured at 916, upon being tested at 918, for example, by the tester 120, the step artifact can be implemented as one of the production objects 108 which is activated at 920 on the development system 130 prior to the method terminating on the end block. If it is determined at 904 that no configuration is required, the method jumps to 920 to activate the production objects 108 and then terminates on the end block.

If it is determined at 902 that code is required, it is further determined at 906 if code already exists within, for example the solutions database 160. If it is determined at 906 that the code exists, then the existing code is used at 908. In order to use the existing code, the API of the development system 130 for updating the code is called. Various portions of the code such as data sources, fields, values of the fields and the like may need to be updated in accordance with the requirements from the requirements documents 114 that are currently being used. Upon updating the code, the syntax of the code is checked at 910, for example, via calling the API for checking the syntax. It is further determined at 912 if the syntax has errors. If the syntax contains errors, the code is flagged for manual fix at 914 and the method terminates on the end block. If it is determined at 912 that the code is error free, the method proceeds to configuring the step artifact at 916, followed by the testing at 918 and the activation of the production objects at 920 prior to the method terminating on the end block.

If it is determined at 906 that no code exists within the solutions database 160, then the code is automatically created at 922, for example, via calling the APIs within the development system 130 for creating the code. The method then returns to 910 to check for syntax errors so that the created code can be flagged for manual fix at 914 if there are syntax errors. Otherwise, the method further proceeds to 916 for executing any required configuration scripts, followed by the testing at 918 and activation of the production objects at 920.

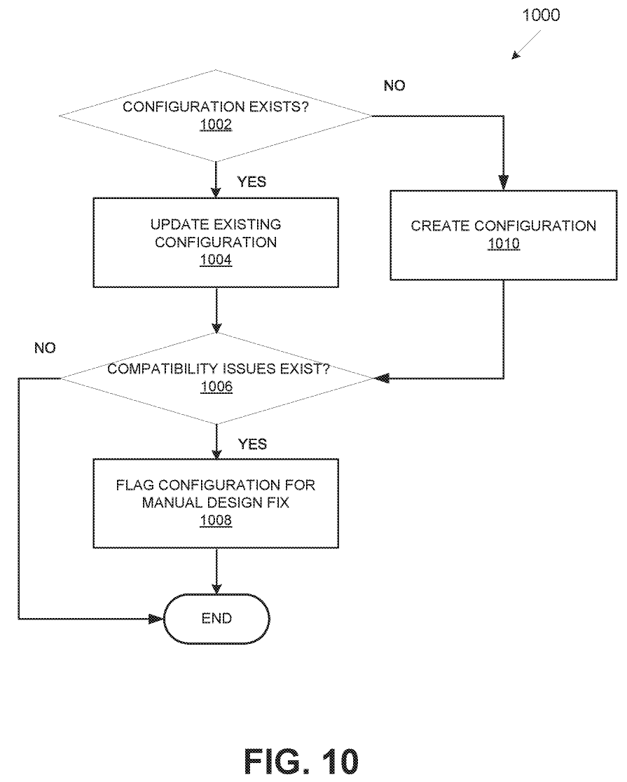

FIG. 10 is a flowchart 1000 that details a method of configuring the step artifact in accordance with an example. The method begins at 1002 wherein it is determined if a configuration script exists, for example, within the solutions database 160 for configuring a step artifact in accordance with the requirements in the requirements documents 114. If it is determined at 1002 that a configuration script exists, the existing configuration is updated at 1004 in accordance with the requirements of the current process step as detailed herein. The updated configuration is checked for compatibility issues or syntax errors at 1006. If compatibility issues or syntax errors exist, the configuration is flagged for a manual design fix at 1008. If no compatibility issues or syntax errors exists, the method terminates on the end block. If, at 1002, it is determined that no configuration script corresponding to the current process requirements exists within the solutions database 160, the method proceeds to 1010 for creating a configuration script which includes lines of code or machine-readable instructions in a specific programming language based on the technology of the production system 180. In an example, the configuration is created manually by a programmer. The script created at 1010 is checked for compatibility issues at 1006 and flagged for manual design fix if compatibility issues or syntax errors are detected, else the method terminates on the end block.

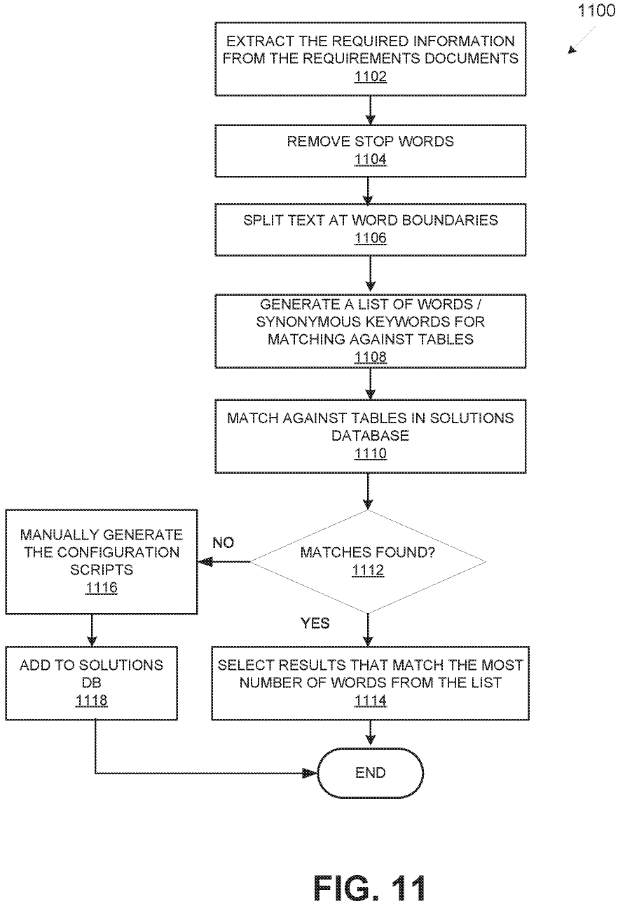

FIG. 11 is a flowchart that details a method of identifying existing code or configuration from the solutions database 160 in accordance with an example. The method begins 1102 wherein pattern matching techniques can be utilized for extracting the necessary information such as name of data sources, required fields, values and the like using regular expressions from the requirements documents 114. At 1104, the stop words are removed from the text extracted at 1102. Upon the removal of the stop words, the text is split out at 1106 by word boundary characters such as whitespaces, commas, new lines and the like to form word tokens. Each resulting word token is passed through Porter-Stemmer algorithm which transforms the word tokens back into their root forms resulting in a list of words at 1108 that are used as the keywords for matching up against the tables in the solutions database 160 at 1110 which contain the configurations, code modules and keywords. The list of words generated at 1108 may also include synonymous keywords selected for example, from the solutions database 160. Accordingly, the search conducted at 1110 may output results associated with both the keywords and the synonymous keywords. It is determined at 1112 if a match was found from the solutions database. If a plurality of matches are found, then the configuration or the code module that has the most number of keywords matching the words from the list is selected at 1114 for generating or developing the production objects 108 and the method terminates on the end block. If it is determined at 1112 that no match was found, the configuration scripts are manually generated at 1116. The configurations that are manually created are added at 1118 to the solutions database 160 and the method terminates on the end block. The solutions database 160 thus increases in size with the usage of the management system generator 150 and as more data is added the instances where configuration scripts need to be manually generated can gradually decrease thereby making the management system generator 150 smarter with passage of time and usage.

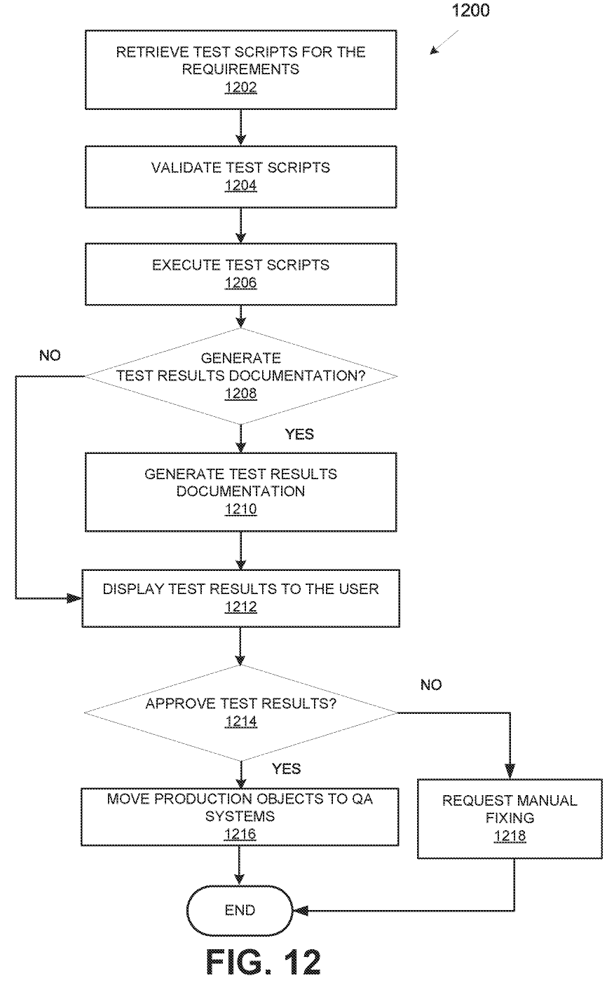

FIG. 12 is a flowchart 1200 that details a method of testing and validation of the production objects 108 in accordance with an example. The method begins at 1202 wherein the test execution script for each of the requirements are retrieved from the corresponding code or configuration script. In an example, the code or configuration scripts may also include the text execution script for each requirement from the requirements documents 114. The retrieved test execution script is then validated at 1204. The corresponding API or Unit Testing Software is used to execute the test execution scripts at 1206. At 1208, input from the user is sought in order to determine if the test results documents 116 that show the results for each unit test for each business requirement are to be generated. If the user responds in the affirmative, the test results documentation is generated at 1210 and the method proceeds to displaying the test results to the user at 1212. If the user does not seek to generate the test results documentation at 1208, the method proceeds to 1212 to display the test results. At 1214, the user's approval of the test results is sought. If the user approves the test results, the production objects 108 are moved to the QA systems 140 at 1216 else if the user rejects the test result, manual fixing of the production objects 108 is requested at 1218.

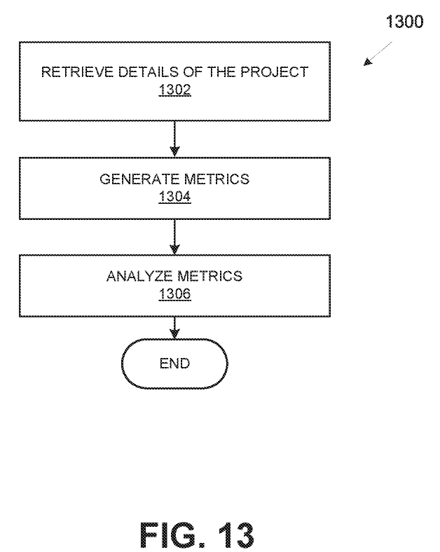

FIG. 13 is a flowchart 1300 that details a method of automatically generating the project metrics in accordance with an example. The method begins at 1302 wherein the details of the project are accessed, for example, from the project transactions database 170. The project metrics are generated at 1304 based on the data from the project transactions database 170. The metrics may include the timeliness and quality parameters achieved by the production objects upon implementation. The metrics are analyzed at 1306 for various purposes such as for determining the success of the production objects 108 in achieving the requirements from the requirements documents 114.

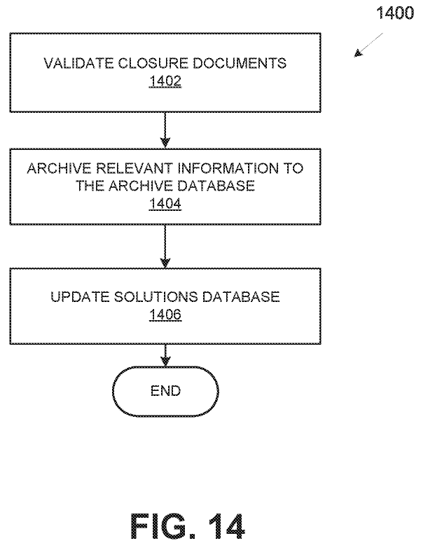

FIG. 14 is a flowchart that details a method of archiving the project data. The method begins at 1402 wherein the project closure documents pertaining to the closure of the project associated with production objects 108 are accessed, for example from the project transactions database 170. The relevant information is archived at 1404 to the archives database 190 that acts as a repository for information pertaining to one or more projects associated with the development system 130. The solutions database 160 is updated with the information from the archiving at 1406 so that the information from the solutions database 160 may help in identifying configurations, templates and processes for future use.

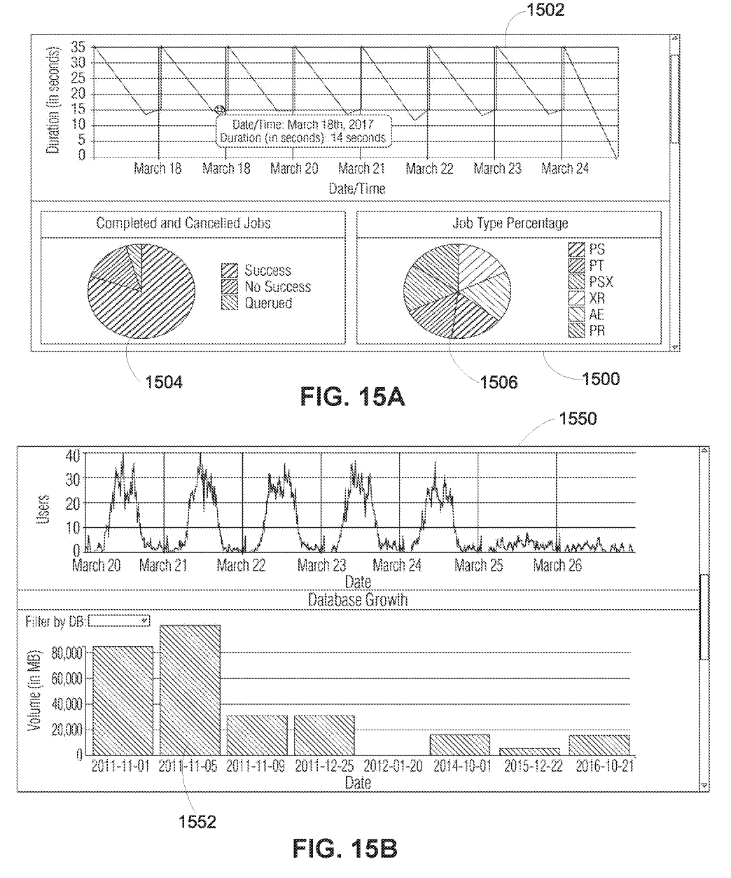

FIGS. 15A and 15B show example user interfaces (UIs) 1500 and 1550 respectively which are automatically generated by the process manager 110 from the requirements documents 114 in accordance with examples detailed herein. The process manager 110 parses the requirements documents 114 for identifying the requirements, identifies the processes and the step artifacts for each of the process steps, generates or otherwise accesses the step artifacts and tests the step artifacts to store the tested step artifacts as output artifacts. In the example UIs 1500 and 1550, the user requirements include transforming data into different visualizations such as line graphs 1502, pie charts 1504, 1506, bar graphs 1552 and the like.

The configuration scripts are required for generating or manipulating step artifacts of various process steps as outlined below. By the way of illustration and not limitation, the process steps and corresponding step artifacts may include but are not limited to:

Step 1: accessing particular data sources that store the data which is to be displayed in the UIs 1500 or 1550. A step artifact for Step 1 may include a piece of configuration script providing access to the data source including security mechanisms such as user names and passwords;

Step 2: retrieving data from the data sources for which the step artifact may include the retrieved data;

Step 3: processing the retrieved data to generate calculations or analysis required for the data visualizations for which the step artifact may include the results of the calculations or output from the analysis; and

Step 4: generating the data visualizations for which the step artifact may include the user interfaces 1500 or 1550 which include respective data visualizations 1502, 1504, 1506 or 1552.

The configuration scripts for the process steps outlined above are obtained from the analytics database 172 or are generated manually and uploaded to the analytics database 172. The production objects 108 generated for the UIs 1500 and 1550 can include without limitation, those objects which work on the backend such as connections to the data sources and the data objects which may include data from the data sources. The production objects 108 may also include objects which work on the front end such as the data visualizations 1502, 1504, 1506, 1552 and the like. Upon generation, the production objects 108 are tested and uploaded to the production system 180 in order to provide users access to the UIs 1500 and 1550. The metrics associated with the automatic generation of the UIs are also generated and stored in the project transactions database 170 while the test results are stored in the archives database 190 for future reference.

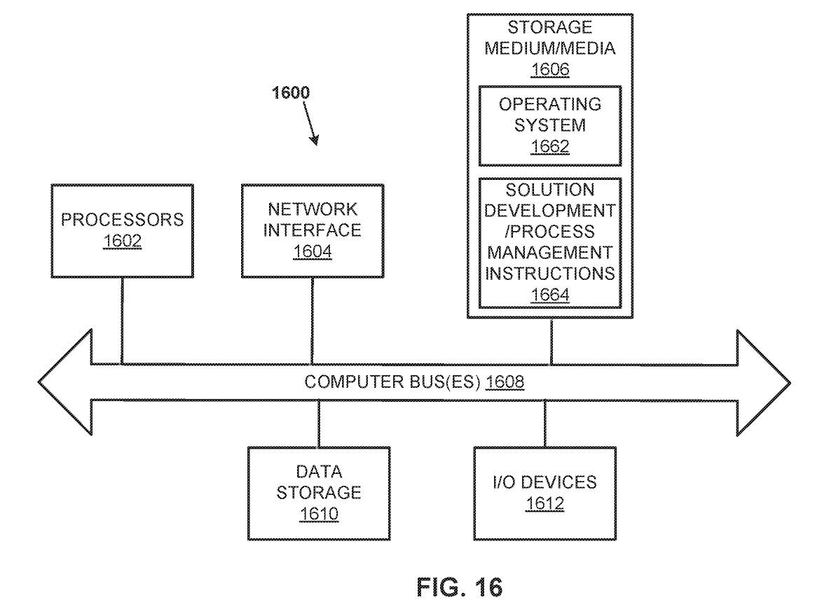

FIG. 16 illustrates a computer system 1600 that may be used to implement one or more of the generators for the process manager 110, documentation-driven application development systems, testing and/or validation systems. More particularly, computing machines such as desktops, laptops, smartphones, tablets, wearables that are used to generate process managers or documentation-driven applications may have the structure of the computer system 1600. The computer system 1600 may include additional components not shown and that some of the components described may be removed and/or modified.

The computer system 1600 includes processor(s) 1602, such as a central processing unit, ASIC or other type of processing circuit, input/output devices 1612, such as a display, mouse keyboard, etc., a network interface 1604, such as a Local Area Network (LAN), a wireless LAN, a 3G or 4G mobile WAN or a WiMax WAN, and a computer-readable medium 1606. Each of these components may be operatively coupled to a bus 1608. The computer readable medium 1606 may be any suitable medium which participates in providing instructions to the processor(s) 1602 for execution. For example, the computer readable medium 1606 may be non-transitory or non-volatile medium, such as a magnetic disk or solid-state non-volatile memory or volatile medium such as RAM. The instructions or modules stored on the computer readable medium 1606 may include machine readable instructions 1664 executed by the processor(s) 1602 to perform the methods and functions for process management system generation, documentation driven solutions development or combinations thereof. The computer readable medium 1606 may also store an operating system 1662, such as MAC OS, MS WINDOWS, UNIX, or LINUX. The operating system 1662 may be multi-user, multiprocessing, multitasking, multithreading, real-time and the like. For example, during runtime, the operating system 1662 is running and the instructions 1664 are executed by the processor(s) 1602.

The computer system 1600 may include a data storage 1610, which may include non-volatile data storage. The data storage 1610 stores any data during various processes described herein. The data storage 1610 may be used to store data such as but not limited to, project documents 102, project metrics, configuration scripts, project templates and the like.

The network interface 1604 connects the computer system 1600 to internal systems for example, via a LAN. Also, the network interface 1604 may connect the computer system 1600 to the Internet. For example, the computer system 1600 may connect to web browsers and other external applications and systems via the network interface 1604.

What has been described and illustrated herein are examples of the disclosure along with some variations. The terms, descriptions and figures used herein are set forth by way of illustration only and are not meant as limitations. Many variations are possible within the scope of the disclosure, which is intended to be defined by the following claims, and their equivalents, in which all terms are meant in their broadest reasonable sense unless otherwise indicated.

What is claimed is:

1. An automatic management system generator comprising:
one or more processors;
a non-transitory data storage comprising instructions that cause the processors to:
access a plurality of project documents in human-readable format that are associated with a project, the project documents comprising details regarding output artifacts to be generated for the project;
parse the plurality of project documents;
obtain word tokens by from the parsed project documents;
extract keywords associated with the project from the word tokens;
retrieve one or more of configuration scripts and processes associated the project by employing the keywords, the configuration scripts comprising machine-executable instructions for configuring the processes;
identify one or more project templates for the one or more processes via employing the keywords;
execute the processes in accordance with the configuration scripts and the project templates, wherein the execution of the processes comprises:
executing steps of the processes;
identifying, based on the project templates, one or more sub-processes comprised in the one or more processes;
executing the one or more sub-processes;
generating respective step artifacts during the execution of one or more of the process steps and the one or more sub-processes;
validating the respective step artifacts; and
store the validated step artifacts as the output artifacts generated by the processes.

2. The automatic management system generator of claim 1, wherein the validated step artifacts form a process manager.

3. The automatic management system generator of claim 1, wherein the instructions to extract keywords associated with the project further comprising instructions that cause the processors to:
process the word tokens via a Porter-Stemmer algorithm to generate a list of keywords.

4. The automatic management system generator of claim 1, wherein the instructions to execute the processes further comprising instructions that cause the processors to:
configure the processes in accordance with the instructions included in the configuration scripts.

5. The automatic management system generator of claim 1, wherein the instructions to execute the processes further comprising instructions that cause the processors to:
load the one or more project templates for the execution of the processes.

6. The automatic management system generator of claim 5, wherein the instructions to execute the processes further comprising instructions that cause the processors to:
execute the processes in accordance with the project templates.

7. The automatic management system generator of claim 1, wherein the output artifacts comprise one or more of documents, deliverables, executable code modules and objects produced, modified or used by the project.

8. The automatic management system generator of claim 1, wherein the instructions to execute the steps of the processes further comprising instructions that cause the processors to:
access input artifacts required for each of the process steps; and
validate the input artifacts prior to the execution of the process steps.

9. The automatic management system generator of claim 1, wherein the instructions to generate respective step artifacts during the execution of one or more of the processes and the one or more sub-processes further comprising instructions that cause the processors to:
access a plurality of requirements documents associated with a project, the requirements documents comprising details regarding the output artifacts to be generated for a project in human-readable format;
obtain word tokens by parsing the requirements documents;
extract keywords associated with the project from the word tokens;
retrieve configuration scripts associated with one or more processes within the project by employing the keywords, the configuration scripts comprising machine-executable instructions for configuring the processes.

10. The automatic management system generator of claim 9, wherein the non-transitory data storage further comprising instructions that cause the processors to:
store information relevant to the processes in a project transactions database;
obtain project closure documents relevant to the project; and
validate the project closure documents.

11. The automatic management system generator of claim 10, wherein the non-transitory data storage further comprising instructions that cause the processors to:
archive the validated project closure documents to an archive database.

12. A method of automatically generating an application comprising:
automatically generating a process manager from one or more project documents;
retrieving, by the process manager, input artifacts comprising information regarding an application to be generated, the input artifacts comprising one or more of configuration scripts, project templates and processes information;
identifying, by the process manager, process steps to be executed for the generation of the application based at least on the input artifacts;
executing, by the process manager, each of the process steps based on one or more of the project templates and the processes information;
generating, by the process manager, step artifacts upon executing the process steps, the step artifacts comprising at least requirements documents detailing requirements for the application;
analyzing, by the process manager, the requirements documents to obtain keywords for generating the application;
generating, by the process manager, production objects comprising machine-readable instructions that meet the requirements identified from the requirements documents;
implementing, by the process manager, the production objects on a development system;
testing the production objects implemented on the development system; and
automatically generating object documentation and test results documents for future use.

13. The method of claim 12, further comprising:
automatically generating, by the process manager, project documents detailing the generation of the process manager.

14. The method of claim 13, further comprising:
fine tuning the process manager based on the project documents.

15. The method of claim 13, wherein executing each of the process steps, by the process manager further comprises:
identifying, by the process manager, sub-processes in each of the process steps; and
executing, by the process manager, the sub-processes identified in each of the process steps.

16. The method of claim 13, wherein generating production objects further comprises:
determining, by the process manager, if the machine-readable instructions exist in a database; and
retrieving, by the process manager, if the machine-readable instructions exist in the database.

17. The method of claim 16, wherein generating production objects further comprises:
automatically generating the machine-readable instructions when it is determined that the machine-readable instructions do not exist in the database.

18. The method of claim 16, wherein generating production objects further comprises:
automatically generating configuration scripts when it is determined that the configuration scripts for the production objects do not exist in the database.

19. A non-transitory computer-readable storage medium comprising machine-readable instructions that cause a processor to:
access a plurality of project documents associated with a project, the project documents comprising details in human-readable format regarding output artifacts to be generated for the project;
parse the plurality of project documents;
obtain word tokens by from the parsed project documents;
extract keywords associated with the project from the word tokens;
retrieve one or more of configuration scripts and processes associated the project by employing the keywords, the configuration scripts comprising machine-readable instructions for configuring the processes;
identify one or more project templates for the one or more processes via employing the keywords;
execute the processes in accordance with the configuration scripts and the project templates, wherein the execution of the processes comprises:
executing steps of the processes;
identifying, based on the project templates, one or more sub-processes comprised in the one or more processes;
executing the one or more sub-processes;
generating respective step artifacts during the execution of one or more of the process steps and the one or more sub-processes;
validating the respective step artifacts; and
store the validated step artifacts as the output artifacts generated by the processes.

20. The non-transitory computer-readable storage medium of claim 19, further comprising machine-readable instructions that cause a processor to:
automatically generate project documents detailing the generation of the output artifacts; and
fine tune the output artifacts based on the project documents.
